(19) United States
(12) Patent Application Publication
(10) Pub. No.: US 2002/0020257 A1
(43) Pub. Date: Feb. 21, 2002

(54) Tube machining and facing apparatus

(76) Inventor: Bernard Emilian, Etoile-Sur-Rhone (FR)

Correspondence Address: PARKHURST & WENDEL, L.L.P., Suite 210, 1421 Prince Street, Alexandria, VA, 22314-2805, US

(21) Appl. No.: 09/840,466

(22) Filed: Apr. 24, 2001

Related U.S. Application Data
(60) Provisional application No. 60/199,358, filed on Apr. 25, 2000.

(51) Int. Cl. B23B 5/04; B23B 5/16

(52) U.S. Cl. 82/113; 82/162

(57) ABSTRACT

A tube squaring machine having an improved feed means and an improved monobloc collet for clamping a workpiece to be machined. A collet mount containing the monobloc collet is mounted on a housing connected to a motor means having a rotatable shaft with a machine tool mounted thereon and positioned relative to the collet to engage tube or workpiece held in the collet.

The monobloc collet is an rigid solid member made from a single piece of material and has a substantially cylindrical hole extending through the member to provide a substantially circular wall. An open slot is provided in the wall. The collet mount contains means to exert pressure on the monobloc collet to close the open slot in the collet to clamp a tube held in the opening of the collet.

This application claims the benefit of provisional patent application No. 60/199,358, filed Apr. 25, 2000.

The present invention relates to tube squaring machines, and in particular to an improved tube squaring machine, an improved collet holder and an improved collet for such machines. In particular, the present invention is an improvement over the apparatus previously known as the Protem SL series of tube machining and facing machines specially made to square the ends of tubes, fittings and tees.

### BACKGROUND OF THE INVENTION

In order to cut a square end on a piece of tubing in a tube facing machine, the machine must attach to the tubing so as to retain the tubing with the axis thereof coaxial with the axis of the drive shaft holding the cutting tool. A collet at the end of the machine is provided to clamp the end of the tube in the desired position.

The collets used in many tube squaring machines are collets with multiple piece pivoted jaws which are held in alignment and brought together by levers or other means, such as disclosed in U.S. Pat. Nos. 4,739,682; 5,671,646; and 5,692,422. In other tube squaring machines collet nuts are tightened to press a tapered annular member against another tapered member to cause the first annular member to grip a tube such as disclosed in U.S. Pat. Nos. 3,228,268 and 4,319,503.

It is also known in the prior art to mount the shafts or spindles of a machine tool in a chuck containing a spring collet, which is a unitary piece of material having several slots cut through the wall of the collet which extend partially along the length of the collet to form spring members. The spring members are compressed to grip the tool, such as disclosed in U.S. Pat. Nos. 4,379,561; 5,788,248; 5,431,416; and 4,690,415. However, these spring collet mechanisms generally require an elaborate mechanism to close the spring collet.

The prior art does not show a collet structure or a tube squaring machine with a collet where the collet is of a very simple structure, inexpensive to manufacture, can be easily closed without an elaborate closure mechanism, and can be easily exchanged for a different size collet to accommodate different size tubes and still hold them with precision alignment.

### SUMMARY OF THE INVENTION

This invention relates to a new and improved tube squaring machine, an improved collet mount, and an improved collet, which provides a simple apparatus which is easier and faster to use in field and on site applications. A tube squaring machine of the invention is shown in FIGS. 1 and 2 and comprises in combination, a housing 4 having a first end and a second end and a tubular section between said ends, a rotatable shaft having a first end and a second end located within said housing and means for attaching a tool to said second end of said rotatable shaft. A drive means is attached to the first end of said shaft. A feed ring having a cylindrical surface with treads thereon is rotatably fitted around said housing 4. A collet base 2 having a generally cylindrical member with a cylindrical surface with threads thereon for mating against said threads of said feed ring 1 is secured to the feed ring with an antirotational means 6 positioned to prevent rotation of said collet relative to said housing 4. The collet base 2 has an opening at the second end adapted to hold a monobloc collet 8. The monobloc collet 8 is positioned in the opening of the second end of the collet base 2 and is held in place by pawls 8. The monobloc collet 8 comprises a generally cylindrical substantially rigid solid member having substantially parallel top and bottom surfaces, a substantially cylindrical opening extending through the member from the top to bottom of said member provides a cylindrical wall with an inner surface for gripping the workpiece. An single open slot in said wall extends across the entire thickness and height of said wall, and opposing recesses in the outer surface of the wall with one recess on each side of said open slot provide opposing surfaces in the surface of the wall which can be clamped together to reduce the width of the space between the opposing slot walls. The collet base has a threaded opening in alignment with one of the recesses on the surface of the thicker wall and a threaded blocking screw mating with said treads in said threaded opening is adapted to engage the surface of the recess to reduce the width of the opening between the faces of the slot in the wall. The collet base has a means for abutting the recess in the outer surface of the wall which opposes the recess which opposes the recess engaged by said blocking screw to prevent rotation to the monobloc collet in the monobloc base.

Another embodiment is shown in FIGS. 5 and 6 where elements 1-6 are as described with reference to FIG. 1, and the collet holder shown in FIGS. 5 and 6 is adapted to hold a circular collet 20 having a substantially circular opening therein centered in the collet. A flat recess is provided in the outer surface of the collet wall at approximately 90 degrees from the open slot in the cylindrical wall for engagement with a threaded screw having a handle thereon as shown by 21 which threaded screw is positioned in a threaded opening in the wall whereby it can be screwed in to close the open slot in the collet.

### BRIEF DESCRIPTION OF THE DRAWINGS

The invention is further explained in conjunction with the following figures illustrating the present invention:

FIG. 1 is a schematic view of the tube machining/facing apparatus of the invention with the improved collet and work advancing feature.

FIG. 2 is a sketch generally corresponding to the collet shown in FIG. 1 and showing details of the collet base with a monobloc collet positioned in the collet base.

FIG. 3 is a small diameter collet for microfittings which is used with the collet base in FIGS. 1 and 2 with a sectional view across A-A.

FIG. 4 is a maximal diameter collet which is used with the collet base in FIGS. 1 and 2 with a sectional view across B-B.

FIG. 5 is a schematic view of a tube machining/facing apparatus of the invention having an improved collet and work advancing feature where the collet holder is adapted to hold a monobloc collet which is substantially cylindrical in shape.

FIG. 6 is a sketch generally corresponding to the collet shown in FIG. 5 showing details of the collet base with a monobloc collet positioned in the collet base.

FIGS. 7 and 8 are schematic views of monobloc collets having opposed recesses for clamping the collet.

FIGS. 9 and 10 are schematic views of monobloc collets having a recess at 22 and 24 which is approximately 90 degrees from the open slot for engaging the clamping screw and secondary slots 23 and 25 extending part of the way through the wall of the collet.

FIG. 11 is a schematic view of a monobloc collet which has secondary slots 27 and 28 extending part way through the wall of the collet and a recess at 26 for engaging a clamping screw.

### DESCRIPTION OF THE PREFERRED EMBODIMENTS

One embodiment of the present invention is an improved collet for holding a workpiece, such as a tube or fitting, to be machined. In another embodiment the collet is locked in a collet base by pawls to allow for fast removal and in a preferred embodiment an advancing mechanism is provided for advancing the collet base and collet toward the machine tool. The collet base and the work advancing means are supported on a housing supporting a motor drive with a machine tool mounted on or connected to the motor drive for machining a workpiece held in the collet.

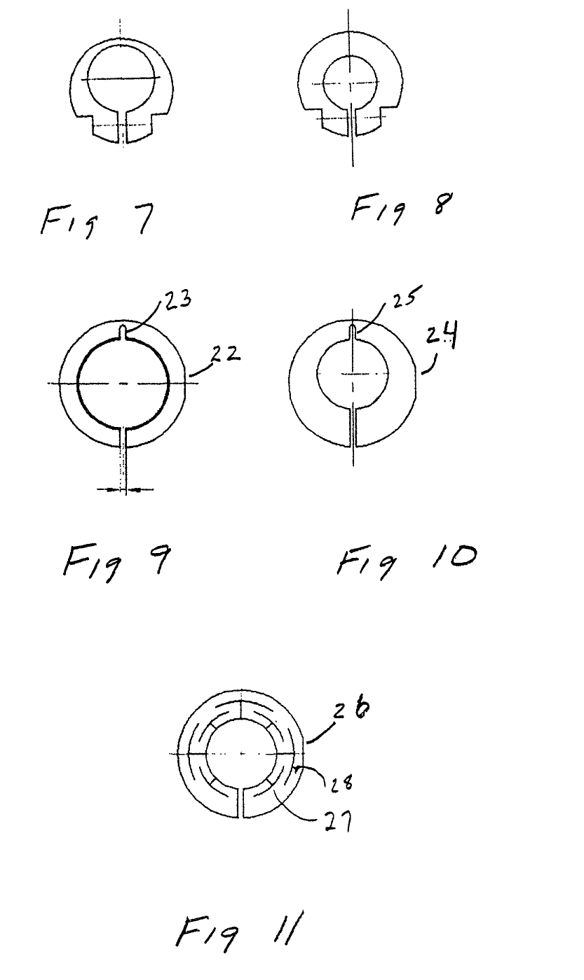

Monobloc collets for releasably holding a tube, in accordance with this invention are shown in FIGS. 3-4 and 7-11. The monobloc collet comprises a generally cylindrical substantially rigid solid member, which can be a plastic material, an alloy steel, aluminum, stainless steel and the like but is preferably made of stainless steel. The collet has substantially parallel top and bottom surfaces, a substantially cylindrical opening 15,16 extending through the member from the top to the bottom of said member providing a substantially cylindrical wall. An single open slot is provided in said wall extending across the entire thickness and height of said wall. Opposing recesses 11,12 and 13,14 in the outer surface of the wall with one recess on each side of said open slot provide opposing surfaces in the wall which can be clamped together to reduce the width of the space between the opposing slot walls, thus, clamping a tube in the substantially cylindrical opening.

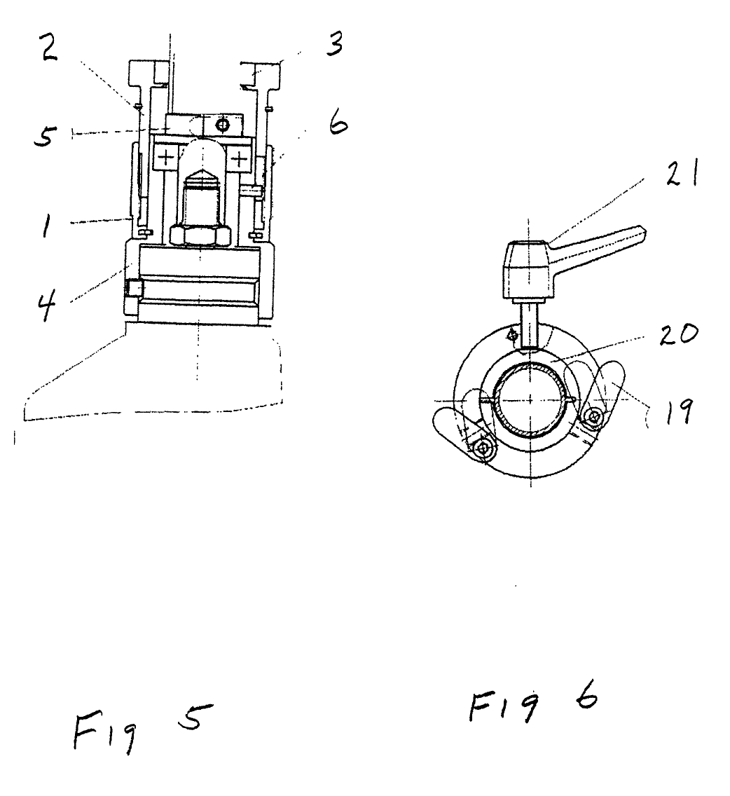

In certain embodiments the substantially cylindrical opening in the monobloc collet is offset as shown in FIGS. 3,4,7 and 10 to one side of said member providing a thin wall opposite a thicker wall which is at least 30% thicker and preferably 100% thicker than said thin wall. An open slot is provided in said thicker wall substantially opposite said thin wall providing opposing slot walls 17,18 and 19,20 extending across the entire thickness and height of said thick wall. Opposing recesses 11,12 and 13,14 in the outer surface of the thicker wall with one recess on each side of said open slot provide opposing surfaces in the thicker wall which can be clamped together to reduce the width of the space between the opposing slot walls, thus, clamping a tube in the substantially cylindrical opening. The collet shown in FIG. 4 is for large size tubes and fittings. The collet shown in FIG. 3 is for small sized tubes and fittings and as shown in FIG. 3 has a cylindrical opening which comprises a small substantially cylindrical opening extending part of the way through the thickness of the member and a larger substantially cylindrical opening extending through the remainder of the thickness of the member. The substantially cylindrical opening in the monobloc collet is positioned to provide a thin wall thickness which has sufficient resilience and flexibility to allow for the closure of the slot faces 17,18 and 19,20 respectively.

In preferred embodiments of this invention the monobloc collet has a substantially cylindrical shape as shown in FIGS. 9 and 10. The cylindrical opening in the collet is preferably centered in the collet as shown in FIG. 9 but it can also be offset as shown in FIG. 10. Preferably, the collet has one flat recess for engagement of the clamping means and such recess or flattened area is preferably approximately 90 degrees from the slot opening as shown by 22 and 23 in FIGS. 9 and 10.

The term monobloc collet as used herein refers to a one piece collet which is preferably made from a single piece of a solid material such as a metal or plastic. This is distinguished from collets which comprise two or more opposing separate jaws for clamping the workpiece. Laminated materials providing a single element can be used to make a monobloc collet. The walls of the monobloc collet are of limited flexibility which term is used here to mean that they are not easily flexed by hand and that generally more than 2 pounds and preferably 5 pounds of force is required to close the open slot in the collet wall.

The monobloc collets of this invention are useful for machining tubes, fittings, elbows and the like having an outer diameter of from ⅛ inches to 20 inches and they are particularly useful for machining tubes, fittings, elbows and the like having an outer diameter of from ⅛ to 5 inches. The monobloc collets have an inner diameter about ⅛ to 20 inches and preferably ⅛ to 5 inches in the clamped position with allowable tolerances for irregular shaped tubes where the workpiece can be secured for machining. The open slot in the monobloc collet can be ½ mm to 10 mm in width between the slot walls and is preferably from 1/2 mm to 3 mm for collets having a opening of ⅛ to 5 inches.

In certain preferred embodiments the monobloc collets have at least one secondary slot extending from the inner surface of the substantially cylindrical wall part of the way through the substantially cylindrical wall as shown as 23 in FIG. 9, 25 in FIG. 10 and 27 and 28 in FIG. 11. This secondary slot increases the flexibility of the collet for closure of the open slot and is preferably located on the opposite side of the substantially cylindrical opening from the open slot and preferably extends from the top to the bottom of the inner wall. More than one secondary slot can be provided, for example, as shown by the secondary slots 27 and 28 which are made with a wire cutter mechanism, but preferably only one secondary slot is provided in the inner wall. The secondary slots provide for a wider range on materials to be used to make the monobloc collet and allow the collets to be used with substantially the same clamping force over a wider range of operating temperatures.

The substantially cylindrical walls of the monobloc collet are at least 1.0 mm in thickness at the thinnest part of the wall and are preferably at least 1.5 mm in thickness at the thinnest part of the wall.

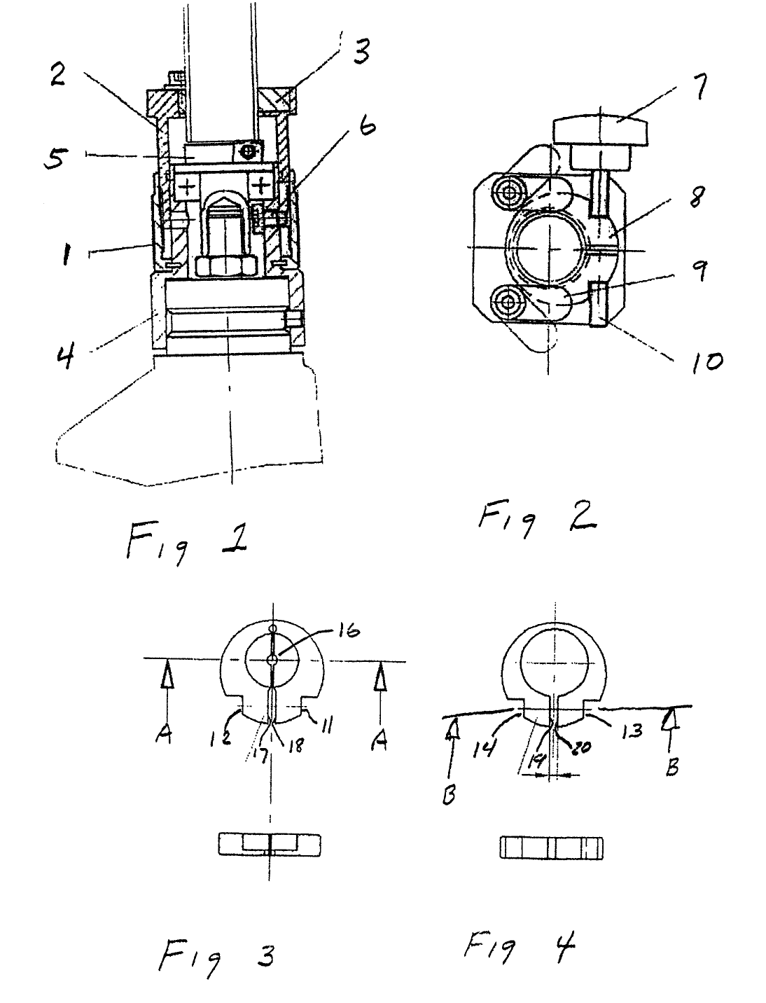

The collet 8 shown in FIGS. 1 and 2 is secured in the collet base 2 by two pawls 9 to provide for easy removal of the collet from the collet base 2 without having to remove screws or other fastening devices. The pawls allow for the easy change of different size collets to accommodate different sizes and shapes of items, such as tubes to be machined. This is especially important where small collets are used to clamp microfittings to be machined. As shown in FIG. 2 the collet 8 has a recess in the outer surface which abuts counter blocking means 10 and a second recess in the outer surface which abuts blocking screw 7. The collet holder has a threaded opening for the blocking screw and the blocking screw is threaded with corresponding threads whereby turning the blocking screw in the threaded opening results in pressure on the recess in the outer surface of the collet to close the slot in the faces of the thick wall of the collet and clamp a tube held in the circular opening of the collet. In preferred embodiments the collet base has means at the second end thereof for preventing transverse movement across the end of the monobloc collet, especially during closing of the open slot in the monobloc collet.

A work advancing means can be used as shown in FIG. 1 where the collet base 2 is held in a machining feed 1 and the collet base 2 can be advanced toward the machine tool in tool holder 5. Rotation of the machining feed, which is a screw mechanism in this embodiment, moves the tube held in the collet toward or away from the machine tool. In this embodiment the tool holder spindle can be fixed by a simple direct connection to the end of the motor drive. This embodiment also allows for quick removal of the collet base by simply unscrewing it from the advancing means for change of collet bases which gives quick access to different types of work holders and for service and change of the machine tools.

Different types of motors can be used in the machining device, including electric, pneumatic or hydraulic motors, or any other type of motor the operator may desire. Similarly, different types of machine tools can be used such as facing tools, beveling tools or other types of machining tools depending on the work to be performed.

The collet base or holder is shown in FIGS. 1 and 2 is a collet base having a generally circular member and means for securing a first end of the collet base to the exterior of a drive means having a rotating a cutting tool, whereby the collet base is fixed in an antirotational relationship with the exterior of the drive means and whereby the collet base can be moved toward and away form the rotating cutting tool, said collet base having an opening at the second end adapted to hold a monobloc collet as described above.

Various means can be used to prevent the collet holder from rotation during operation. Screw 6 held in the machine body mount 4 shown in FIG. 1 engages a slot as shown in the cylindrical walls of the collet base and is effective to prevent rotation of the collet base.

While I have illustrated and described my invention by means of specific embodiments, it is understood that changes and modifications of the various elements may be made without departing from the spirit and scope of the invention as defined in the appended claims.

1. A monobloc collet, for releasably holding a tube, comprising a generally cylindrical substantially rigid solid member having substantially parallel top and bottom surfaces, a substantially cylindrical opening extending through the member from the top to bottom of said member providing a substantially cylindrical wall, an open slot in said wall providing opposing slot walls extending across the entire thickness and height of said wall, and at least one recess in the outer surface of the said wall for engagement with a clamping means to reduce the width of the space between the opposing slot walls.

2. A monobloc collet according to claim 1 wherein said substantially cylindrical opening is centered in the collet.

3. A monobloc collet according to claim 1 wherein the thinnest wall of said collet is at least 1 mm in thickness.

4. A monobloc collet according to claim 1 wherein the member is made from a single piece of stainless steel.

5. A monobloc member according to claim 1 wherein the width of said open slot is from 0.5 mm to 10 mm between the opposing faces of said slot.

6. A monobloc member according to claim 1 wherein said collet contains a secondary slot extending from the inner wall of said cylindrical opening part of the way through said wall.

7. A monobloc member according to claim 1 wherein said secondary slot is located at the opposite side of the cylindrical opening from said open slot.

8. A monobloc collet according to claim 1 wherein said cylindrical opening is offset to one side of said member providing a thin wall opposite a thicker wall which is at least 30% thicker than said thin wall, an open slot in said thicker wall substantially opposite said thin wall providing opposing slot walls extending across the entire thickness and height of said thick wall, and opposing recesses in the outer surface of the thicker wall with one recess on each side of said open slot providing opposing surfaces in the thicker wall which can be clamped together to reduce the width of the space between the opposing slot walls.

9. A monobloc collet according to claim 1 wherein said cylindrical opening comprises a small substantially cylindrical opening extending part of the way through the thickness of the member and a larger substantially cylindrical opening extending through the remainder of the thickness of the member.

10. A monobloc collet according to claim 8 wherein the thicker wall is 100% thicker that the thin wall.

11. A monobloc collet apparatus for releasably holding a tube in a fixed position relative to a cutting tool comprising:
a) a collet base having a generally circular member and means for securing a first end of the collet base to the exterior of a drive means having a rotating a cutting tool, whereby the collet base is fixed in an antirotational relationship with the exterior of the drive means and whereby the collet base can be moved toward and away form the rotating cutting tool,
b) said collet base having an opening at the second end adapted to hold a monobloc collet,
c) a monobloc collet positioned in the opening of the second end of the collet base, said monobloc collet comprising a generally cylindrical substantially rigid solid member having substantially parallel top and bottom surfaces, a substantially cylindrical opening extending through the member from the top to bottom of said member providing a substantially cylindrical wall, an open slot in said the wall providing opposing slot walls extending across the entire thickness and height of said wall, and at least one recess in the outer surface of the wall,
d) said collet base having a threaded opening in alignment with the recess on the surface of the wall and a threaded blocking screw in said treaded opening adapted to engage the surface of the recess to reduce the width of the opening between the faces of the slot in the wall.

12. A monobloc collet apparatus according to claim 11 wherein said collet base has means at the second end thereof for preventing transverse movement of the monobloc collet.

13. A tube facing machine comprising in combination, a housing having a first end and a second end and a tubular section between said ends, a rotatable shaft having a first end and a second end located within said housing and means for attaching a tool to said second end of said shaft and a drive means connected to the first end of said shaft, a feed ring having a cylindrical surface with treads thereon fitted said housing for rotation on said housing, a collet base having a generally cylindrical member with a cylindrical surface with threads thereon for mating against said threads of said feed ring and antirotational means positioned to prevent rotation of said collet base relative to said housing, said collet base having an opening at the second end adapted to hold a monobloc collet, a monobloc collet positioned in the opening of the second end of the collet base, said monobloc collet comprising a generally cylindrical substantially rigid solid member having substantially parallel top and bottom surfaces, a substantially cylindrical opening extending through the member from the top to bottom of said member providing a substantially cylindrical wall, an open slot in said wall extending across the entire thickness and height of said wall, and at least one recess in the outer surface of the wall, said collet base having a threaded opening in alignment with a recess on the surface of said wall and a threaded blocking screw in said treaded opening adapted to engage the surface of the recess to reduce the width of the opening between the faces of the slot in said wall.

14. A tube facing machine according to claim 13 wherein said collet base has means at the second end thereof for preventing transverse movement of the monobloc collet.

15. A tube facing apparatus according to claim 13 wherein said substantially cylindrical opening is centered in the collet.

16. A tube facing apparatus according to claim 13 wherein the thinnest wall of said monobloc collet is at least 1 mm in thickness.

17. A tube facing apparatus according to claim 13 wherein the monobloc collet is made from a single piece of stainless steel.

18. A tube facing apparatus according to claim 13 wherein the width of said open slot in the monobloc collet is from 0.5 mm to 10 mm between the opposing faces of said slot.

19. A tube facing apparatus according to claim 13 wherein said monobloc collet contains a secondary slot extending from the inner wall of said cylindrical opening part of the way through said wall.

20. A tube facing apparatus according to claim 19 wherein said secondary slot is located at the opposite side of the cylindrical opening from said open slot.

21. A tube facing apparatus according to claim 13 wherein said opening in said monobloc collet is offset to one side of said member providing a thin wall opposite a thicker wall which is at least 30% thicker than said thin wall, an open slot in said thicker wall substantially opposite said thin wall providing opposing slot walls extending across the entire thickness and height of said thick wall, and opposing recesses in the outer surface of the thicker wall with one recess on each side of said open slot providing opposing surfaces in the thicker wall which can be clamped together to reduce the width of the space between the opposing slot walls.

22. A tube facing apparatus according to claim 13 wherein said cylindrical opening in said monoblock collet comprises a small substantially cylindrical opening extending part of the way through the thickness of the member and a larger substantially cylindrical opening extending through the remainder of the thickness of the member.

23. A tube facing apparatus according to claim 21 wherein the thicker wall of said monobloc collet is 100% thicker that the thin wall.
